(19) United States
(12) Patent Application Publication
(10) Pub. No.: US 2013/0293711 A1
(43) Pub. Date: Nov. 7, 2013

(54) REMOTE SURVEILLANCE SYSTEM

(71) Applicants: Anuj Kapuria, Haryana (IN); Sushant Gupta, Haryana (IN); Jyoti Vij, Haryana (IN); Sharad Mehta, Haryana (IN); Hemant Dandekar, Haryana (IN)

(72) Inventors: Anuj Kapuria, Haryana (IN); Sushant Gupta, Haryana (IN); Jyoti Vij, Haryana (IN); Sharad Mehta, Haryana (IN); Hemant Dandekar, Haryana (IN)

(21) Appl. No.: 13/882,070

(22) PCT Filed: Oct. 27, 2011
(86) PCT No.: PCT/IN11/00745

§ 371 Date: Jul. 18, 2013

(30) Foreign Application Priority Data
Oct. 26, 2010 (IN) 2559/DEL/2010

(51) Int. Cl. H04N 5/225

(52) U.S. Cl. CPC H04N 5/2252
USPC 348/143

(57) ABSTRACT

A remote surveillance system with different types of sensors and electronics moulded and embedded in a shell kind of package in such a way so as to make the complete system rugged enough and throwable up to a distance. The system may be deployed in a location wherein it is desired to remotely capture a video, environmental and voice data.

### FIELD OF INVENTION

The present invention relates to robotic systems. More specifically, it describes a novel remote surveillance system, device or unit that is readily deployable in remote areas, efficient and easy to install in applications involving surveillance in relatively inaccessible area such as areas of deep ocean or areas pertaining of hazardous environmental condition.

### BACKGROUND

Today's Surveillance devices and systems typically lack user—friendliness, ease of use/installation, correct monitoring of information, especially, in areas with harsh environmental conditions. Further, the quality of data captured by surveillance devices often suffers from lack of audio quality or video/image resolution. Moreover, collection of information from potentially hazardous environments or sending information directly to a person in such areas, without the information of the surroundings hazards and dangers involves huge risk of life of a person.

Therefore, there is a need of a system which obtains and displays such video and voice data correctly along with environmental information from surrounding environments.

### SUMMARY

According to embodiments of the present invention, there is provided a remote surveillance system with different types of sensors and electronics moulded and embedded in a shell kind of package in such a way so as to make the complete system rugged enough and throwable up to a distance. The system may be deployed in a location wherein it is desired to remotely capture a video, environmental and voice data.

According to one of the preferred embodiment, the shell of the remote surveillance system may optionally be covered by rubber of a certain hardness to provide rigidity and make it shock resistant. The electronics and sensors embedded in the shell are in a watertight position, thus making the complete system immersible in the water. Further, the remote surveillance device is capable of 360 degrees rotation on its axis with its base stationary on the ground and upper portion of the sensor rotatable and ability to align itself with the earth axis to generate electronic data in accordance with electromagnetic energy incident thereon. The electronics of the system are operable in both day and night. Moreover the camera inside the sensor is capable of tilting along the vertical axis perpendicular to the ground thus making it a complete PAN TILT sensor.

The sensor is motorized and capable of motion in any direction or axis if desired so by attaching motors and magnetic wheels along with mechanical suitable assembly with or within the sensor.

According to another embodiment of the present invention the electronics assembly of the said device comprises of one or more camera assemblies, a power source with an optional charging terminal, environmental sensors and a device external communication interface along with infra red led array, a highly sensitive microphone and a motor to provide rotation to on its axis, a microcontroller unit, an embedded PCB board along with electronics and data and audio, video transmitters and receivers capable of operating at the desired frequencies. The sensor can house chemical, biological, nuclear, laser and various types of optional sensors if desired so.

An advantage of the remote surveillance device is that it is a readily deployable surveillance device in high risk or inaccessible locations or situations where it is desired to remotely capture video or voice or both. It can be thrown up to a distance of 60 m with landing on debris, piles, stones, concrete floor earth, grass or any other landing surface, self righting with respect to gravity axis and capable of providing 360 degrees data in a hostile and harsh environment.

Another advantage of embodiments of the present invention is that of night vision capability up to 10 m and the remote surveillance device can provide continuous video and voice data for more than one hour.

Another advantage of embodiments of the present invention is that a remote surveillance system can operate autonomously and/or under well-defined instructions transmitted remotely from a remote information processing unit through RF link.

### BRIEF DESCRIPTION OF DRAWINGS

The detailed description is described with reference to the accompanying figures. In the figures, the left-most digit of a reference number identifies the figure in which the reference number first appears. The same numbers are used throughout the drawings to reference like features and components

FIG. 1 illustrates a block diagram representation of deployable remote surveillance system in accordance with the present invention.

FIG. 2 illustrates a pictorial representation of deployable remote surveillance device in accordance with the present invention.

FIG. 3 illustrates a cross-sectional view of the remote surveillance device of FIG. 2 according to an embodiment of the present invention.

### DETAILED DESCRIPTION

Exemplary embodiments now will be described with reference to the accompanying drawings. The invention may, however, be embodied in many different forms and should not be construed as limited to the embodiments set forth herein; rather, these embodiments are provided so that this invention will be thorough and complete, and will fully convey its scope to those skilled in the art. The terminology used in the detailed description of the particular exemplary embodiments illustrated in the accompanying drawings is not intended to be limiting. In the drawings, like numbers refer to like elements.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

The specification may refer to “an”, “one” or “some” embodiment(s) in several locations. This does not necessarily imply that each such reference is to the same embodiment(s), or that the feature only applies to a single embodiment. Single features of different embodiments may also be combined to provide other embodiments.

As used herein, the singular forms “a”, “an” and “the” are intended to include the plural forms as well, unless expressly stated otherwise. It will be further understood that the terms “includes”, “comprises”, “including” and/or “comprising” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations and arrangements of one or more of the associated listed items.

Unless otherwise defined, all terms (including technical and scientific terms) used herein have the same meaning as commonly understood by one of ordinary skill in the art to which this invention pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way.

The figures depict a simplified structure only showing some elements and functional entities, all being logical units whose implementation may differ from what is shown. The connections shown are logical connections; the actual physical connections may be different.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Embodiments of the present disclosure include systems and methods for remote surveillance and applications therefor.

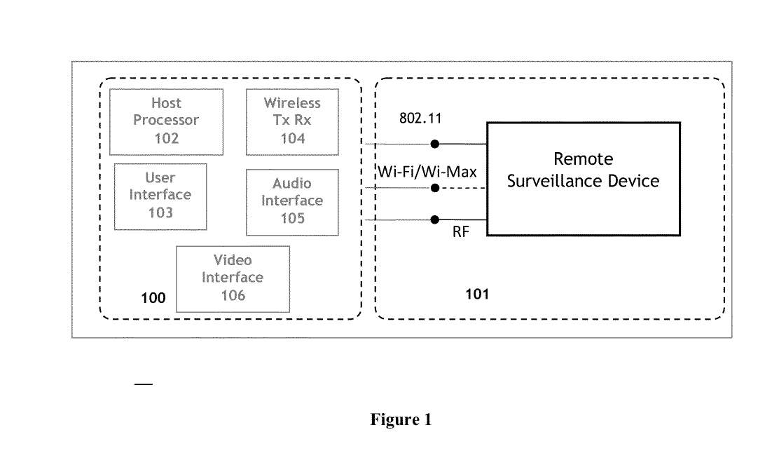

FIG. 1 illustrates a block diagram representation of deployable remote surveillance system in accordance with the present invention. The remote surveillance system includes an information processing unit 100 communicatively coupled to a remote surveillance device 101. Further, the information processing unit 100 includes a host processor and control unit 102, a user interface 103, one or more wireless transceivers 104 and an audio interface 105 and a video interface 106 operatively coupled with each other.

In the preferred embodiment, host processor and control unit 102, may be any known computer system, including, for example, a personal computer such as a laptop computer, a minicomputer, a mainframe computer, a personal digital assistant (PDA), or multiple computers in a system or any like. The host computer system may support any architecture or have any operating system (OS) running or may be without an OS with just embedded applications running to support the command, control and data transfer and retrieval functions. Typically, internal components of host will also include at least one processor, as well as random access memory (RAM). The processor can be directly connected to display, or remotely over communication lines such as telephone lines, local area networks, or any other network for data transmission. Host preferably is configured to run on a Linux® operating system (an open source software platform).

In another preferred embodiments, user interface 103 includes an advisory display panel, a control display panel, an environmental sensor display panel, and an image display panel. These displays presents all collected audio, video and environmental information collected and transmitted by remote surveillance device. Any known or suitable user interface for interaction with cameras and/or sensors can be used.

In another preferred embodiment, wireless transceivers 104 transmit and receive the environmental audio and video data via communication link. Communication link is a two-way communication link provided by device external communication interface and host external communication interface Communication link is preferably a wireless communication interface, such as an 802.11(b) signal, or any other 802.11 wireless communication interface or “Wi-Fi” or “Wi-Max” or any other RF communication interface, as are commonly known in the art. The transmitted data is preferably formatted by central processor to be divided into a series of “messages,” each message containing data representing one or more obtained images, audio and/or environmental sensor information. Each message is time stamped for subsequent analysis purposes, and converted into standard TCP/IP or UDP/IP protocols by central processor, as is commonly known in the art.

Further, the received environmental, audio and video data by the host processor is preferably stored in random-access memory (RAM) for immediate presentation purposes. Alternatively, or in addition to being stored in RAM, the received environmental, audio and video data is stored on a hard drive for future analysis and/or presentation. Also, host processor decompresses or decrypts audio, video or environmental data that was compressed or encrypted prior to transmission.

Furthermore, said advisory display panel displays hardware, software, and/or data advisories related to the operation of the remote surveillance device and/or communication link. These advisories include various color codes and other images associated with various alert levels, categories, and alarms to be presented to the operator. A separate panel provides an operator interface for review of past advisories. Alarms are available for each environmental sensor or environmental condition. If a certain environmental condition is detected (for example a threshold temperature), an alarm is displayed in advisory display panel. All such thresholds are XML configurable items and linked to a particular environmental condition detected. In addition to that, operator of host processor is provided with capability to set thresholds on environmental sensor display panel.

Control display panel displays and provides a user interaction with controls for managing information and images displayed on user interface. For example, control panel includes a timeline scroll bar for adjusting between the display of current and stored past images and environmental information in user interface. Control display panel also displays and provides interaction with controls for multiple remote surveillance devices and select a preferred remote surveillance device deployed and operative at the same time.

Environmental sensor display panel provides a flexible layout for presenting all collected environmental information from environmental sensors. Environmental sensor display panel is dynamically reconfigurable to a single or multi-column format to show all the sensors reporting from the deployed unit. Environmental information is dynamically and automatically added to environmental sensor display panel as it is received. In the event that more environmental information is received than can be reasonably displayed in environmental sensor display panel, a vertical scroll bar is provided to scroll amongst environmental information.

Environmental sensor display panel displays separate sub-panels for the environmental information captured by each environmental sensor of the remote surveillance device or, alternatively, displays separate sub-panels for each environmental condition detected or tested separately. A separate XY chart and/or sensor icon is displayed for each environmental sensor and/or environmental condition displayed. The XY chart displays a time history on the X axis and a level on the Y axis.

Environmental sensor display panel is also configured to adjust characteristics of displayed information according to various thresholds (for example, in accordance with alert levels triggering alerts in advisory display panel). The sensor icon and/or XY chart may vary in characteristics such as color, size, or format according to detected environmental conditions. The characteristics are stored so that an operator of the remote surveillance device can review previous environmental information to see which sensors have exceeded thresholds at anytime in the past.

According to another embodiment, user interface also includes an image display panel configured to display video obtained by camera assemblies of remote surveillance device. Images are dynamically and automatically added to image display panel as they are received. In the event that more images are received than can be reasonably displayed in image display panel, a horizontal scroll bar is provided to scroll amongst present and past images. Each individual image panel preferably has control buttons configured to, for example, rotate the individual image clockwise, provide a cursor crosshair, zoom to a cursor crosshair, and/or maximize the individual image to take up the entire display area of user interface.

According to the preferred embodiment of the present disclosure, the audio interface 105 provided in the information processing unit includes a earphone jack or speakers to provide audio surveillance data.

According to the preferred embodiment of the present disclosure, the video interface 106 provided in the information processing unit to display the images and videos of surveillance data.

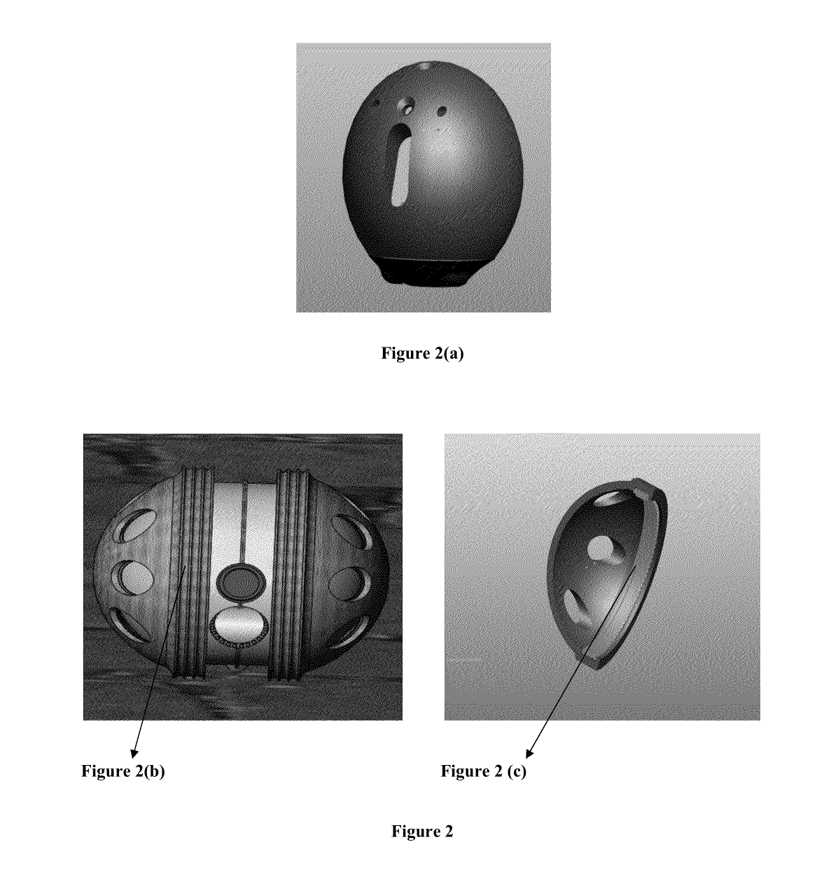

FIG. 2 illustrates a pictorial representation of deployable remote surveillance device in accordance with the present invention. The remote surveillance device 101 comprises an shell as shown in FIG. 2(a), spherical in shape, having a top surface and a bottom surface. A spherical-shaped shell provides for easier deployment of said device because the shape allows rolling and maintaining direction during its trajectory flight. It can be easily understood by a person skilled in the art that the shape of shell can be a cylindrical, conical, capsule, cubiodial, hexagonal, octagonal, and pyramidal or any polygonal shape.

Preferably, shell has dimensions that permit the remote surveillance device to be deployed, for example, by hand, and thus preferably has a maximum size that is less than 90 mm in diameter on any one exterior surface, and more preferably, 90 mm including outer rubber cover on all sides. The minimum size of the shell will be determined by the space required to house the electronics assembly and the thickness of the shell.

Further, the wall of shell includes an inner structural layer providing the structural integrity of the shell, an insulating layer for mitigating the effects of environmental heat on electronics assembly, and an outer layer for covering and protecting electronics assembly and other components of the remote surveillance device.

Structural layers is formed from known and readily available formable materials such as, for example, nylon, polyurethane, Teflon or any like. Insulating layer is designed to be safe for use in temperatures in excess of 80 degrees Celsius. Insulating layer also provides shock absorption protection for the inner structural layer and electronics assembly. Insulating layer is formed from known and readily available formable insulating materials such as, for example, silica aerogels, ceramics, thermoplastic polyimides, Nanopore thermal insulation, or fiberglass.

Outer layer provides covering protection to the other layers of shell and the components of the remote surveillance device. Outer layer also includes openings for one or more camera portals or sensors. In addition to that, outer layer provides magnetic wheels as shown in FIG. 2(b). These wheels have magnetic coils or solenoid embedded in it and covering the shell circumferentially as shown in FIG. 2(c). When the robot is required to climb a ferrous wall or a ferrous surface and the robot needs to stick to the surface, a powerful DC current is passed through the coil embedded in the wheels of the, which in turn produces a powerful magnetic effect and makes the robot stick to the surface. When we want to move the robot up on the surface, DC current is introduced in to the coils at a particular frequency in synchronization with the well-defined instructions given to move the robot. Whenever it is required to decouple this robot from the ferrous surface and move it on the normal surface we simply switch off the DC current passing in to the coils. This simple mechanism helps the robot to move up on ferrous bodies.

Outer layer is not protected by any insulation, and thus must be capable of withstanding temperatures and/or other environmental elements of hazardous environments. A material that burns, melts, or corrodes could interfere with operation of camera assemblies and/or environmental sensors, potentially disabling the device. Outer layer provides some insulation to the other layers and electronics assembly.

Outer layer is formed from known and readily available formable materials such as, for example, polyimide film, aluminum foams, fiberglass, or rubbers. In one of the preferred embodiment, the remote surveillance device may also includes a phase change material (PCM) layer to further protect electronics assembly from heat. Phase change materials are materials designed to exploit the fact that a change between phases of matter (solid, liquid, gas) either absorbs or releases energy. PCM's for electronics are designed to change from solid to liquid. By including PCM within shell, the phase change absorbs energy that would otherwise cause an increase in temperature. The phase change, then, prolongs the amount of time electronics can survive when they are being heated. However, while PCM helps protect against environmental heat, it also acts as an insulator and does not allow the dissipation of heat generated internally by electronics assembly. Thus, the use of PCM may reduce run time of sensor device in a room-temperature environment.

In another embodiment, said device include phase change material for use in high-temperature environments, and other similar devices that do not include phase change material for non-high-temperature environments (i.e., environments with an ambient temperature less than the maximum operational temperature for electronic elements).

In one embodiment of a sensor device including PCM, phase change material is an additional layer of shell. Alternatively, the interior of shell is filled with loose phase change material. Loose phase change material is available in microencapsulated or non-microencapsulated form. Microencapsulated PCM comprises numerous microcapsules each having a core that changes phase while suspended within a shell that stays solid. Thus, microencapsulated PCM remains granular, even after multiple use cycles, and will not melt together into a large block, unlike non-microencapsulated PCM. In addition to selecting between microencapsulated or non-microencapsulated PCM, considerations in selecting a suitable PCM for phase change material include the energy required for phase change (usually expressed in terms of kilojoules per kilogram or kJ/kg), and the phase change temperature indicating the temperature at which the PCM changes phase. Microencapsulated PCM material typically provides lower energy absorption than non-microencapsulated PCM.

Preferably, when device used in high-temperature environments, shell includes phase change material requiring a high energy for phase change (usually expressed in terms of kilojoules per kilogram or kJ/kg) and having a phase change temperature slightly lower than the upper temperature limit of electronic elements in electronics assembly (for instance, slightly lower than 185 degrees Fahrenheit for preferred electronic elements). For example, Microtek® MPCM-52D® PCM is a microencapsulated PCM with a phase-change energy of approximately 139 kJ/kg and a melting point of approximately 125 degrees Fahrenheit. Other exemplary PCM materials include Honeywell Astor® Astorphase 54® PCM, a non-microencapsulated PCM with a phase-change energy of 220 kJ/kg and a melting point of approximately 129 degrees Fahrenheit, and Rubitherm® RT 54® PCM, a non-microencapsulated PCM with a phase-change energy of 181 kJ/kg and a melting point of approximately 134 degrees Fahrenheit.

Additinally, a shock-absorbing casing is provided to covers inner shell of the surveillance device. This shock-absorbing casing provides protection to the structural and electrical components of the device. Casing is located on the exterior of said device and not protected by any insulation, and thus must be capable of withstanding temperatures and/or other environmental elements of hazardous environments. Preferably, casing is made from silicone rubber such as Silastic silicone rubber. The other part of the device containing the sensors and electronics can also be moulded in polyurethane or any elastomer, so that they can withstand the harsh conditions.

The exterior appearance of the remote surveillance device is made such that it can obtain environmental information, voice and videos, in accordance with embodiments described herein. The remote surveillance device, therefore, is configured to a size and weight such that a person is capable of moving the device into the environment. For example, a person can deploy said device by picking it up and throwing it into the environment. Thus, the remote surveillance device can be thrown, deployed by remote device (e.g., a launcher, pneumatic gun), dropped out of a vehicle, or through any other means of moving the device into the environment.

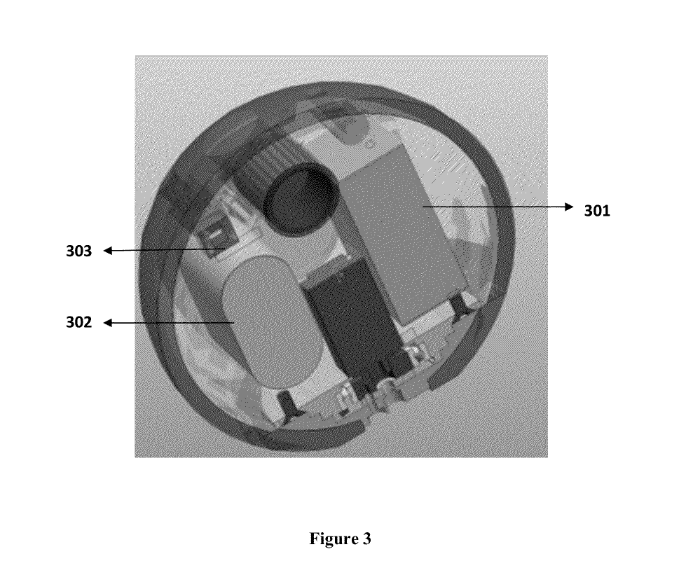

FIG. 3 illustrates internal configuration of the remote surveillance device in accordance with the present invention. The remote surveillance device includes an electronic assembly 301, a sensor assembly 302, tether attachment connector and a counterweight counter.

In the preferred embodiment sensor assembly 301 houses infra red emitters, sensors, microphone, environmental, chemical, biological and nuclear sensors along with and camera and microphone portals. Further, it includes an electronics assembly 302. This electronic assembly includes electronic elements coupled to a central processor of the device. Furthermore, the electronic elements include one or more camera assemblies, a power source with an optional charging terminal 303, environmental sensors coupled to an environmental sensor amplifier, a board temperature sensor, a microcontroller that receives signals from the environmental sensor amplifier and/or the board temperature sensor, and a device external communication interface along with infra red led array, a highly sensitive microphone and a motor to provide rotation to the device on its axis.

Central processor is configured to provide central control, data acquisition, and communication support for sensor device. Central processor receives environmental information from the various environmental sensors, videos from camera assemblies, voice data from microphone, user commands to operate the motor and sensors and supports wireless communication via a device external communication interface. The environmental information, voice and videos received by the central processor may be either analog or digital, and thus central processor is configured to receive either analog or digital signals, and to provide analog-to-digital conversion of received analog signals. Alternatively, a separate analog-to-digital converter is included in electronics assembly (such as in microcontroller). Central processor is also preferably configured to provide compression (i.e., JPEG or MPEG-2 compression) of high-bandwidth digital data, such as still or video images, prior to the transmission of the digital data to host processor) via the device external communication interface.

The sensors include one or more environmental sensors configured to detect the presence of and/or levels of various gaseous and other environmental conditions, including, but not limited to: hydrogen sulfide; oxygen; carbon monoxide; carbon dioxide; chlorine; hydrocarbons; smoke; heat; nuclear and other radiation; poisonous gases and/or particles (e.g., anthrax); and fire suppression agents.

Environmental sensors are commonly configured to generate an analog signal indicating the presence of and/or a level of an environmental condition. This analog signal generated by environmental sensors typically ranges from less than 0.1 microamps to approximately 100 microamps, depending upon the configuration of the particular environmental sensor and the type and amount of the detected environmental condition in the atmosphere. Electronics assembly also includes an environmental sensor amplifier configured to amplify the analog signals generated by environmental sensors. Amplification is often necessary to render the generated analog signals conducive to analog-to-digital conversion. For instance, typical circuits providing analog-to-digital conversion require received analog signals in the range of zero (0) to five (5) volts. Thus, environmental sensor amplifier is configured to provide varying levels of amplification for various environmental sensors, depending upon the amplitude range of the analog signal generated by the respective environmental sensor.

In another exemplary embodiment—a camera portal is made up of a transparent material affixed in side surface providing for light to pass through the camera portal to a camera assembly inlaid within the side surface. Camera portal is a pane of translucent material, such as, for example, quartz crystal glass, or translucent hardened plastics. Alternatively, the camera portal can be a lens of the camera assembly itself. Each camera portal is flush with the side surface in order to provide better rolling characteristics. Each side surface and camera portal is sealed to prevent water, smoke, and other hazards contained in the external environment from permeating into the device.

Primarily, camera assembly includes a small board-level camera circuit and camera lens. The camera circuit can either consist of a bare circuit board along with a lens mount, thus requiring minimal additional circuitry for each camera assembly, or separated sets of components integrated into a single hardened mother board. Camera assembly also includes a camera interface for transmitting obtained videos to a base station using wireless, audio, video transmitter using wireless link.

Embodiments of camera assembly employ any type of imaging system, including infra-red or other non-visual spectra. For example—cameras, within the visible range, includes CMOS or CCD imaging. While CCD camera assemblies tend to offer better intensity discrimination, CMOS camera assemblies tend to offer faster readout and lower power consumption. Camera assembly is configured to obtain video images, or, alternatively, still images. Camera assembly is configured to obtain color or monochromatic (i.e., black and white) images at any desired resolution that is available. Camera assembly may be selected based upon a variety of factors, including resolution, sensitivity, size, weight, durability, camera interface, and method of exposure control.

In the preferred embodiment, camera assembly includes a monochrome CCD imager assembly, with a USB interface configured to operate with the commonly used processors such as Windows® or Linux®. Camera lens has a focal length preferably in the range from 1.7 mm to 3.6 mm, and most preferably 2.5 mm. However, other focal lengths are within the scope of this invention. Camera assembly also includes a converter circuitry to provide analog-to-digital conversion of the obtained image signal. Alternatively, camera assembly outputs an analog image signal to central processor, and central processor provides analog-to-digital conversion.

In one of the embodiment, camera lens is perpendicular to the respective side surface. In another embodiment, camera lens is located at an angle to the respective side surface. For example, camera lens can be directed at an angle slightly above parallel to the ground level, providing greater coverage of the environment.

Referring back to the FIG. 2 the visible side surfaces of the device also includes sensors such as environmental sensors. In the preferred embodiment of the device, environmental sensors for detecting and measuring levels of oxygen, hydrogen sulfide, and carbon monoxide in an environment would be used. It should be understood, however, that remote surveillance device could be configured to detect the presence and/or levels of any environmental condition in which there exists a commercially available environmental sensor. Various environmental sensors are known in the art, and are configured to detect temperature, smoke, or levels of various gaseous elements in the environment. For instance, known environmental sensors include sensors that detect the presence and/or levels of: hydrogen sulfide; oxygen; carbon monoxide; carbon dioxide; chlorine; hydrocarbons; smoke; heat; nuclear and other radiation; poisonous gases and/or particles (e.g., anthrax); and any Nuclear, biological and chemical sensors known in the art and fire suppression agents.

Moreover, the electronic elements in electronics assembly are sensitive to levels of heat and cold. For instance, temperatures in excess of 185 degrees Fahrenheit can render electronic elements inoperative. In addition, to ambient heat frequently present in hazardous environments, electronics assembly receives heat generated by the normal operation of electronic elements such as power source and central processor. Electronics assembly also includes a board temperature sensor that is configured to monitor the temperature of a portion of the electronics assembly, and provide internal temperature information to host. Board temperature sensor is configured to generate an analog or digital signal indicating the internal temperature of the electronics assembly.

Further, analog signals generated by environmental sensors and/or board temperature sensor are preferably converted to digital signals prior to processing by central processor and transmission via device external communication interface. In one embodiment, central processor is configured to provide analog-to-digital conversion of analog signals. In another embodiment, analog-to-digital conversion of analog signals is provided by a microcontroller before the signals are provided to central processor. Microcontroller includes analog-to-digital converters configured to sample analog signals from environmental sensors and/or board temperature sensor.

In the preferred embodiment, microcontroller provides the digitized signals to central processor through a serial interface, such as a RS-232 interface.

Microcontroller, for example, also includes its own software package configured to provide for acquisition of analog signals from environmental sensors and/or board temperature sensor, analog-to-digital conversion of the received analog signals, and transmission of these signals to central controller. Such a software package can be written in standard C or C++ programming platform. Alternatively, the software package is adapted for use in sensor device using an open-sourced platform, such as a version of Linux® for microcontrollers, or any like.

Power source, a part of electronic assembly, provides power to electronic elements including central processor and/or microcontroller. Power source directly powers other elements of electronics assembly such as camera assemblies, environmental sensors, environmental sensors amplifier, board temperature sensor, and/or device external communication interface.

Alternatively, power source powers some or all of these elements of electronics assembly through their respective interfaces with central processor and/or microcontroller. For instance, camera assemblies are interfaced to central processor via a serial USB interface that provides a power signal to camera assemblies as well as providing for the transmission of data.

Further, power source preferably comprises one or more NiMH batteries or LI-Ion or LIPO batteries. NiMH batteries typically have a nominal voltage of 1.2 volts. LI-Ion or LIPO battery cell typically have a nominal voltage of 3.7 v without charge, which can go upto 4.2 v on full charge status. For example, in the preferred embodiment, central processor and microcontroller tolerates a voltage range from approximately 3.3 to 5.3 volts. Thus, four NiMH batteries, each providing a 1.2 volt charge, are linked in series to provide a 4.8 volt charge to central processor and microcontroller or two cell lithium Ion battery array may be used along with suitable voltage regulator to power the electronics and different sensors as per their operating voltage range.

Electronics assembly also includes a device external communication interface for transmitting video, voice and environmental data, and other information to host via communication link and receive user commands depending on the usage and need of the time or as the operator may deem fit. External communication interface is preferably configured to transmit digital data via a wireless signal, such as a “Wi-Fi” 802.11 signal, over a range of 100 feet or more. External communication interface is preferably configured to transmit data formatted in standard TCP/IP or UDP/IP protocols. External communication interface preferably provides a two-way communication interface, so that sensor device receives control and other information from host processor and control unit 101 via communication link. Embodiments of external communication interface comprise a wireless device and an antenna (located either external or internal) that provides wireless 802.11 transmission of TCP/IP or UDP/IP data over 400 feet along with a wireless transmitter for audio video data over of 30 m as per the transmission power of the equipment used. Any RF equipment operating in any restricted or license free frequency zone may be used. In the preferred embodiment, there is only one communication link for both video and command/control and another embodiment with two communication links, one dedicated to audio, video data the other for environmental and situation data transmission along with command control data which can also incorporate encryption and decryption algorithms as per the user choice or configuration or as may deem fit for a particular operation or mission or use.

According to another embodiment of the present invention, the remote surveillance device includes a charging terminal on the exterior of shell. The charging terminal is used to charge and/or recharge a power source. The charging terminal is preferably located on a top surface of the shell. Alternatively, charging terminal can be located on a side surface or bottom surface of the shell. The charging terminal is configured to allow serial charging of multiple similar remote surveillance devices when the sensors are stowed; for instance, a charging terminal located on a top and a bottom surface of a sensor device provides for charging of the respective power sources of multiple sensor devices when the multiple sensor devices were stacked on top of one another.

According to another embodiment of the present invention, the bottom surface of the shell of the remote surveillance device, that is, a surface intended to rest on the floor when device comes to rest, includes extra weighting such as a layer or object not included in other surfaces of the shell. The extra weighting of the bottom surface provides for improved deployment of the device when it is thrown or otherwise deployed, it is more likely that none of the side surfaces having camera portals and environmental sensors will be facing the ground and thus incapacitated.

According to another embodiment of the present invention, the remote surveillance device includes a tether attachment connector to enable retrieval of the device, for example—a mechanical means that connects to the tether attachment connector. The tether attachment connector is located on a lower surface of sensor device that is designed to face downwards when the remote surveillance device is at rest. The tether attachment connector, for example, can be a hook, a magnetic or electro-magnetic connection device, or any other connection device designed to allow attachment by a mechanical means, such as a pole or hook. The tether attachment connector is preferably flush with or inlaid in a surface of the shell to minimize the effect of the tether attachment connector on the rolling trajectory of the device. For obtaining environmental information audio and video data using device described above, at least one said device is activated and deployed. It is activated, for example, by a control signal transmitted from host to sensor device, by removing a charge from charging terminal, by activating a switch on device, or by any other means of activating an electronic device.

Alternatively, said device is configured to remain activated during its functional lifetime, or during all times when it may be deployed. Preferably, the device is deployed manually (i.e., by hand) by a person. It should be understood that the device may be activated either before or after deployment.

An advantage of the remote surveillance system as described herein is designed for easy deployment on hard, hostile and hazardous environments for humans in any manner. It is applicable for remote viewing by law enforcement, fire department, or military personnel before entering a building, corridor or other confined area where danger might be hidden. It establishes a “trip-wire” barrier or perimeter in areas not easily or safely accessible, such as roofs of buildings in urban areas, across inaccessible or dangerous terrain, etc and leaving “” in areas where it is not feasible or desirable to maintain a continuing human presence.

Moreover, while embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution.

Further examples of machine-readable storage media, machine-readable media, or computer-readable (storage) media include but are not limited to recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof.

Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above detailed description of embodiments of the disclosure is not intended to be exhaustive or to limit the teachings to the precise form disclosed above. While specific embodiments of, and examples for, the disclosure are described above for illustrative purposes, various equivalent modifications are possible within the scope of the disclosure, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges.

In the drawings and specification, there have been disclosed exemplary embodiments of the invention. Although specific terms are employed, they are used in a generic and descriptive sense only and not for purposes of limitation.

We claim:

1. A remote surveillance system comprising:
a remote surveillance device comprising:
a shell structure;
on board sensor assembly;
on board electronic assembly;
a tether attachment connector;
a counterweight counter is a fixed mass or rotating elliptical mass to facilitate orienting the structure in a specific direction with respect to ground; and
a remote information processing unit operatively coupled to said remote surveillance device;
wherein said remote surveillance device is designed to rotate 360 degrees in any axis, move in any direction and climb a ferromagnetic surface by producing magnetic effect when deployed in any hazardous environment.

2. The system as claimed in claim 1, wherein said shell structure forms one of a sphere, cylindrical, conical, capsule, cubiodial, hexagonal, octagonal, an ovoid, pyramidal or a polyhedral shape.

3. The system as claimed in claim 1, wherein said shell structure comprises:
an inner structural layer;
an insulating layer; and
an outer layer.

4. The system as claimed in claim 3, wherein said inner structural layer is made up of formable materials such as Nylon, Polyurethane, Teflon or any like.

5. The system as claimed in claim 3, wherein said insulating layer is made up of materials such as Silica Aerogels, Ceramics, Thermoplastic polyimides, Nanopore thermal insulation or fiberglass.

6. The system as claimed in claim 3, wherein said outer layer comprises:
one or more opening for imaging sensors; and
a plurality of magnetic wheels.

7. The system as claimed in claim 3, outer layer is made up of formable materials such as Polyamide film, Aluminum foams, Fiberglass, Elastomers or Rubbers.

8. The system as claimed in claim 6, wherein said magnetic wheels are magnetic coils and solenoid covering the shell circumferentially.

9. The system as claimed in claim 6, wherein said magnetic coils are excited by a powerful DC current which in turn produces a powerful magnetic effect and makes the device to stick to a ferromagnetic surface.

10. The system as claimed in claim 6, wherein said magnetic coils are excited by a powerful DC current at a particular frequency which allows said remote surveillance device to climb a ferromagnetic surface

11. The system as claimed in claim 1, wherein on board sensor assembly comprises:
one or more video cameras;
environmental sensors;
volume sensors;
acoustic sensors;
vibration sensors; and
temperature sensors

12. The system as claimed in claim 11, wherein said video cameras are CMOS camera assemblies or CCD Camera assemblies.

13. The system as claimed in claim 11, wherein said environmental sensors comprises:
gas sensors to detect the presence and or level of: hydrogen sulfide, oxygen, carbon monoxide, carbon dioxide, chlorine, hydrocarbons, etc. smoke sensors;
chemical sensors; and
nuclear radiation sensors.

14. The system as claimed in claim 1, wherein said on board electronic assembly comprises:
a processing and control unit;
a communication unit comprising a transmitter and a receiver;
a drive sub-system comprising electric motors; and
a power source.

15. The system as claimed in claim 14, wherein said electric motors work on back emf based feedback mechanism.

16. The system as claimed in claim 14, wherein said electric motors work on encoder based feedback mechanism.

17. The system as claimed in claim 14, wherein said power source comprises:
a battery array providing power to sensors, charging coil and other electronic components fitted in the said remote surveillance device;
a capacitor;
a gyro;
a flywheel;
a dynamo;
a fuel cell;
a thermoelectric generator;
a clockwork mechanism; and
a solar cell.

18. The system as claimed in claim 17, wherein said battery array is charged by a charging terminal.

19. The system as claimed in claim 1, wherein said tether attachment connector is a mechanical attachment such as a hook, a magnetic or electro-magnetic connection device, or any other connection device designed to allow attachment by a mechanical means.

20. The system as claimed in claim 1, wherein said remote information processing unit comprises:
a host processor and control unit;
a memory to store both raw and processed data and images;
one or more wireless transceivers;
a user interface;
an audio interface; and
a image and video display interface.

21. The system as claimed in claim 1, wherein said remote information processing unit and remote surveillance device are configured to operate in complete harmony.
